(19) United States
(12) Patent Application Publication
(10) Pub. No.: US 2026/0118252 A1
(43) Pub. Date: Apr. 30, 2026

(54) ACCURACY OF ELECTROPHORETIC MOBILITY MEASUREMENTS BY APPLYING A SLOW FLOW

(71) Applicant: Wyatt Technology, LLC, Goleta, CA (US)

(72) Inventors: Steven P. Trainoff, Santa Barbara, CA (US); Shivakumar Ramini, Newbury Park, CA (US)

(21) Appl. No.: 19/375,591

(22) Filed: Oct. 31, 2025

Related U.S. Application Data
(60) Provisional application No. 63/714,408, filed on Oct. 31, 2024.

(51) Int. Cl. G01N 15/1434; G01N 15/10; G01N 15/14; G01N 15/1404; G01N 15/1409

(52) U.S. Cl. CPC G01N 15/1436; G01N 15/1409; G01N 2015/1006; G01N 2015/1422; G01N 2015/1493

(57) ABSTRACT

A computer implemented method comprises flowing a sample through a sample cell at a flow rate; applying an electric field to the sample while the sample is flowing through the sample cell; and measuring electrophoretic mobility of particles in the sample using light scattering techniques while the sample is flowing and the electric field is applied. The flowing removes degraded sample particles from a measurement region of the sample cell during the measuring and replaces the degraded sample particles with a fresh sample. The flowing removes heat generated by Joule heating from the measurement region. The flowing enables an application of a higher electric field strength, thereby increasing a Doppler shift and reducing measurement time and measurement error.

### RELATED APPLICATION

This application is a non-provisional patent application claiming priority to U.S. Provisional Patent Application No. 63/714,408, filed Oct. 31, 2024, titled “Improving Accuracy of Electrophoretic Mobility Measurements by Applying a Slow Flow,” which is incorporated herein by reference in its entirety.

### FIELD OF THE INVENTION

The disclosed technology generally relates to light scattering instruments. More particularly, the disclosed technology relates to measuring electrophoretic mobility using light scattering techniques.

### BACKGROUND

When performing electrophoretic mobility measurements, a small electrical current is applied to a sample having charged molecules or particles. This can degrade fragile samples during a measurement operation. If, in an attempt to improve statistical accuracy a user either increases the applied field or the measurement time, a degraded sample may be measured.

### SUMMARY

In accordance with one aspect, a computer implemented method comprises flowing a sample through a sample cell at a flow rate; applying an electric field to the sample while the sample is flowing through the sample cell; and measuring electrophoretic mobility of particles in the sample using light scattering techniques while the sample is flowing and the electric field is applied. The flowing removes degraded sample particles from a measurement region of the sample cell during the measuring and replaces the degraded sample particles with a fresh sample. The flowing removes heat generated by Joule heating from the measurement region. The flowing enables an application of a higher electric field strength, thereby increasing a Doppler shift and reducing measurement time and measurement error.

In some embodiments, the flow rate has a range of 0-1.0 mL/min.

In some embodiments, the method further comprises accompanying the electrophoretic mobility measurement with a simultaneous Dynamic Light Scattering (DLS) measurement of a hydrodynamic radius of the particles in the sample.

In some embodiments, the sample cell comprises at least two electrodes spaced to define a measurement volume, and wherein the sample is refreshed within the measurement volume at predetermined intervals of approximately 30 seconds to maintain accuracy of the mobility measurement throughout a duration of the flowing of the sample.

In some embodiments, an increased electric field is applied across the at least two electrodes to induce a higher electrophoretic velocity in the sample, thereby producing a greater Doppler shift.

In some embodiments, the light scattering techniques include a detector comprising a heterodyne interferometer configured to measure the Doppler shift induced by scattering light off the particles.

In some embodiments, measuring a scattering spectrum by the light scattering techniques comprises: acquiring intensity data as a function of Doppler frequency shift; fitting the acquired spectrum to extract a spectral width indicative of Brownian motion; calculating a diffusion coefficient from the spectral width using a known scattering wave vector; and determining a hydrodynamic radius of the particles using a Stokes-Einstein relationship based on the diffusion coefficient, a known solvent viscosity, and a known temperature.

In some embodiments, the electric field is applied perpendicular to a direction of the flowing.

In some embodiments, the electric field is applied parallel to a direction of the flowing, and wherein the flowing separates a sample scattering peak from a stray light peak in a scattering spectrum.

In another aspect, a method for improving sensitivity and accuracy of electrophoretic mobility measurements comprises applying a slow flow to continuously remove a sample from a measurement cell during a measurement operation involving an application of electrical current; replacing the removed sample with fresh sample during the measurement operation; applying higher electric fields than would be possible without the slow flow; and extending measurement times beyond what would be achievable without the slow flow. The continuous removal and replacement of sample enables the application of higher fields and longer measurement times, thereby improving sensitivity and accuracy of the measurement operation.

In some embodiments, the measurement operation comprises: applying the electrical current forming an electric field to the sample while the sample is flowing through the measurement cell; and measuring electrophoretic mobility of the particles in the sample using light scattering techniques while the sample is flowing and the electric field is applied.

In some embodiments, the light scattering techniques comprise electrophoretic light scattering using a heterodyne method that measures Doppler shift induced by scattering light off moving particles.

In some embodiments, the electric field is applied perpendicular to a direction of the flowing.

In some embodiments, the electric field is applied parallel to a direction of the flowing, and wherein the flowing separates a sample scattering peak from a stray light peak in a scattering spectrum.

In some embodiments, the stray light peak remains at a Doppler shift of 0 Hz while the sample scattering peak shifts due to the flowing, thereby enabling measurement of particles in low optical quality sample cells.

In some embodiments, during the slow flow, electrolysis products and degraded sample particles are from a measurement region of the measurement cell and replaced with the fresh sample.

In some embodiments, the flowing of the sample removes heat generated by Joule heating from the measurement region.

In another aspect, a system for electrophoretic mobility measurement comprises a sample cell configured to contain a sample having particles; a flow system configured to flow the sample through the sample cell at a non-zero flow rate; electrodes configured to apply an electric field to the sample in the sample cell; and a light scattering detector configured to measure electrophoretic mobility of the particles while the sample flows through the sample cell and the electric field is applied, wherein the flow system is configured to continuously remove electrolysis products and degraded sample particles from a measurement region and replace them with fresh sample.

In some embodiments, the electrodes are configured to apply the electric field perpendicular to a direction of flow of the sample through the sample cell.

The system of claim 18, wherein the electrodes are configured to apply the electric field parallel to a direction of flow of the sample through the sample cell, and wherein the flow system is configured to separate a sample scattering peak from a stray light peak in a scattering spectrum.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a diagram illustrating a comparison between measurement results of a stationary sample and a sample in motion at a predetermined flow rate, in accordance with embodiments of the present inventive concept.

FIG. 2 is a graph illustrating measurement results with respect to a hydrodynamic radius, in accordance with embodiments of the present inventive concept.

FIG. 3 is a graph illustrating an effect of field strength to stop-flow and slow-flow measurements, in accordance with embodiments of the present inventive concept.

FIG. 4 is a graph of a scattering spectrum, in accordance with embodiments of the present inventive concept.

FIGS. 5 and 6 are graphs of a Lysozyme spectrum in a flow cell, in accordance with embodiments of the present inventive concept.

FIG. 7 is a graph illustrating peak widths as a function of an applied flow performed by a method according to embodiments of the present inventive concept.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments of the present inventive concept apply a slow applied flow where a sample such as a sample degraded during a measurement involving an application of electrical current is continuously removed from the measurement cell and replaced with a fresh sample. This allows measurement operations to be performed that apply higher fields and longer measurement times, which greatly improve the sensitivity and accuracy when applying a measurement technique.

When a sample of particles (or molecules) is subjected to an electric field, the charged particles accelerate in response. Counteracting their motion is the frictional force of the solvent. The system rapidly reaches an equilibrium velocity which balances these two forces. The ratio of equilibrium velocity to the applied field is defined as the electrophoretic mobility. For aqueous particles the velocity that must be measured is quite small. For example, with a typical applied field of 1V/mm, particles of polystyrene latex beads only develop a velocity of

$$- 4.2 \frac{μm}{sec} .$$

Because this velocity is so small, mobility measurements have traditionally been performed under stop-flow conditions. Historically it was not considered possible to measure samples under flow because it was believed that the applied flow would overwhelm the small electrophoretic velocity.

One common way of measuring electrophoretic mobility is by using electrophoretic light scattering (ELS) techniques. Instruments like the Malvern ZetaSizer™, Wyatt Mobius™, or Waters/Wyatt ZetaStar™ measure the electrophoretic velocity by using a heterodyne method that measures the Doppler shift induced by scattering light off the moving particles. U.S. Pat. No. 10,422,768 (referred to hereinafter as “application '768”) the content of which is incorporated by reference herein in its entirety teaches a method and apparatus for applying flow perpendicular to the applied field so that the resulting Doppler shift is largely unaffected by flow. This enables mobility measurements of flowing samples. The subject of this disclosure is to describe a technique applied to application '768 to improve electrophoretic mobility measurements of fragile or otherwise challenging samples. It also covers the case in which the flow is aligned with applied field, and shows that the effect of stray light can be mitigated by the presence of flow.

As described above, electrophoretic mobility has long been used to characterize the charge of molecules and particles. It is a standard tool used to measure stability of colloids and other particle suspensions. In recent years it has been used increasingly for proteins and other small biomolecules. Many of these samples are relatively fragile and only available in small quantities. Modern instruments have been designed to minimize the volume of sample required, which necessarily means that the electrodes that apply the field are close to the volume probed by the instrument optics. Electrophoretic light scattering consists of measuring the magnitude of the Doppler shift in the intensity spectrum of the scattered light, which is used as a direct measure the electrophoretic velocity. The Doppler shift is proportional to the average motion, which in turn is proportional to the applied field. One obvious strategy to improve the measurement is to increase the Doppler shift by applying a higher field, but this often leads to accelerated degradation of the sample. The time that one can measure the sample before it is unacceptably degraded drops, which counteracts the benefit of the greater Doppler shift. The net result is that increasing the applied field provides only a marginal improvement in data quality. If the field is too large, then it may not be possible to get a good measurement at all! Balancing these, the magnitude of the applied field and the acquisition time must be optimized by the user for each sample.

Even with robust samples, as the measurement proceeds the solvent undergoes electrolysis. If the solvent is water, hydrogen and oxygen gas are generated near the electrodes. If the volume of gas evolved at the electrodes is small, it will remain in solution. However, at higher applied currents, the solution can reach saturation, and additional gas will evolve as bubbles that interfere with the measurement. This can be mitigated by pressurizing the cell during the measurement as taught in U.S. Pat. No. 9,335,250) the content of which is incorporated by reference herein in its entirety. Henry's law states that the solubility of dissolved gas is proportional to pressure, so if the cell is pressurized to 30 bar, it can hold 30× as much gas in solution compared to if the measurement were conducted at 1 bar. This eliminates the problem of bubble formation, but there is another problem with solvent electrolysis. Aqueous buffers usually contain salts. The electrolysis products of the buffer salts can be highly reactive. For example, if the buffer contains sodium chloride, one of the electrolysis products is sodium hypochlorite (bleach), that accelerates sample degradation.

The practical consequence is that to make successful measurements, one must balance the competing effects of solvent composition, field strength, sample volume, and measurement time. It often happens that one can only measure a sample for a limited time before it degrades, or solvent electrolysis corrupts the results.

Historically mobility measurements were made by manually loading a cell, ensuring that there are no bubbles, and then doing a 30 sec to 5 min collection.

A popular method simplifying the manual process is to use an autosampler to deliver samples to a flow cell. In some embodiments, an autosampler integration for an instrument uses a chromatography pump to flush solvent through the cell to ensure that it is clean and bubble free. A back pressure regulator pressurizes the flow cell to 30 bar during the flushing process. Then the autosampler injects a bolus of sample into the cell, the pump is turned off, and the measurement is made. The back pressure regulator holds the pressure during a stop-flow measurement of the mobility which prevents bubble formation. Because of the aforementioned issue with stability, there is a limit on how long the sample can be measured before it degrades. For challenging samples, it often happens that the measurement has unacceptably poor reproducibility, as measured by the standard deviation of replicate measurement, or one inadvertently measures sample after it has degraded, and the measurement is inaccurate. When the measurement is complete, the chromatography pump flushes the flow cell, and the spent sample is sent to waste, and the system is ready to measure the next sample.

### The Benefits of Applying Slow-Flow During ELS Measurements

If one has a challenging sample, the automation solution allows for replicate injections to be performed. By making replicate injections the accuracy is improved. However, the requirement to flush out spent sample, flush with solvent and inject a replicate, is time consuming and requires a lot of material. The subject of this invention is to rely on the concepts of application '768 incorporated by reference above to improve the data quality and be much more parsimonious with sample consumption. The key observation is that instead of doing a stop-flow measurement one can do a slow-flow measurement. This has many benefits. With a slow applied flow during the measurement, any electrolysis gas or degradation products are flushed from the cell during the measurement and are continuously replaced with fresh sample. The field that drives the electrophoretic motion is proportional to the current and inversely proportional to the conductivity. Therefore, when measuring samples in a high conductivity solvent, one must use a correspondingly high applied current. This in turn can result in substantial Joule heating of the sample. The applied flow also serves to flushes out warm sample replacing it with cool sample, preventing a net temperature rise. The result is that the user may apply higher fields than would otherwise be possible, because there is no corresponding reduction in the maximum measurement time. So long as there is a continuous flow of fresh sample, one can continue measuring indefinitely thereby improving the measurement accuracy.

Consider an example that highlights the sample and time required to do a measurement. In this example, the flow cell used in a measuring device has a port-to-port volume of 130 μl. To ensure that the cell is fully filled with sample, one typically over-fills by a factor 3×, requiring a minimum sample load of around 350 μl per injection. Further assume that one can safely measure the sample for 30 seconds before degraded material diffuses into the measurement region. If the sample has a low mobility, one might want to achieve a total measurement time of 5 minutes to get good statistics. With the automation solution described above the time required to flush solvent, inject samples, and measure takes approximately 5 minutes per injection, but most of this is spent flushing and injecting. Only 30 seconds is allocated to the measurement. To achieve 5 minutes of measurement time, the entire process must be repeated 6 times for a total run time of 30 min, consuming a total of 2.1 mL of sample.

When using the slow-flow method in accordance with the present inventive concept, one must refresh the sample within the between the electrodes once every 30 seconds. For the flow cell described above the volume between the electrodes is only 20 μl. To completely replace this volume every 30 seconds, one only requires a flow rate of 0.04 ml/min. To achieve the desired 5 min measurement time, this would only consume an extra 180 μl (4.5 additional minutes at 0.04 ml/min) beyond the initial 350 μl injection, for a total sample load of 530 μl. The slow-flow method is more parsimonious than the multiple injection stop-flow method.

There is another benefit of the slow-flow measurement protocol. In the WatersWyatt ZetaStar™ product, the mobility measurement is accompanied with a simultaneous Dynamic Light Scattering (DLS) measurement of the particle hydrodynamic radius. It is well-known that DLS measurements can be corrupted by small amounts of dust. If the sample contains a dust particle and one does a stop-flow measurement, it often happens that the dust particle will diffuse into and out of the beam, corrupting multiple measurements. When one does the same measurement on a slowly flowing sample, the dust particle enters and exits the beam as a pulse, which only affects a single measurement.

### Experiment Validation

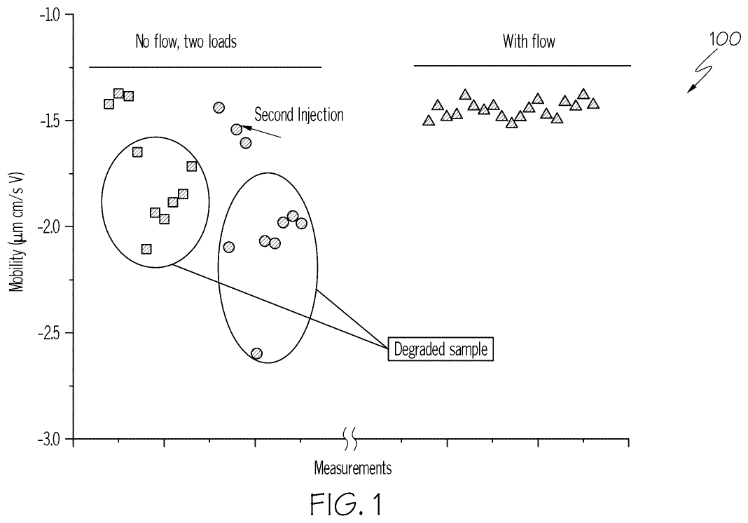

The slow-flow measurement scheme was tested by comparing the default stop-flow measurement protocol to the slow-flow measurement method. The sample was Sigma Bovine Serum Albumen (BSA) prepared at 1 mg/ml in a solvent of 15 mM PBS (phosphate buffer saline). This sample was measured in the ZetaStar™ product under stop-flow conditions and using a slow-flow protocol with the sample flowing continuously at 0.1 ml/min. BSA mobility can be measured with an accuracy of roughly 12% in 60 seconds using an applied current of 2 mA. In an attempt to improve accuracy, the sample was measured with an applied current of 6 mA, but this leads to accelerated degradation as shown in the graph 100 illustrated in FIG. 1. On the left graph are shown data from two injections of the stop flow measurement. The first few measurements on the left (squares) are clustered around −1.4 μm cm/sec (MBU), but then rapidly diverge. The second injection (circles) shows a similar issue. In contrast the slow-flow measurement on the right shows no long-term evolution. One can improve the statistics by integrating for as long as fresh sample is applied.

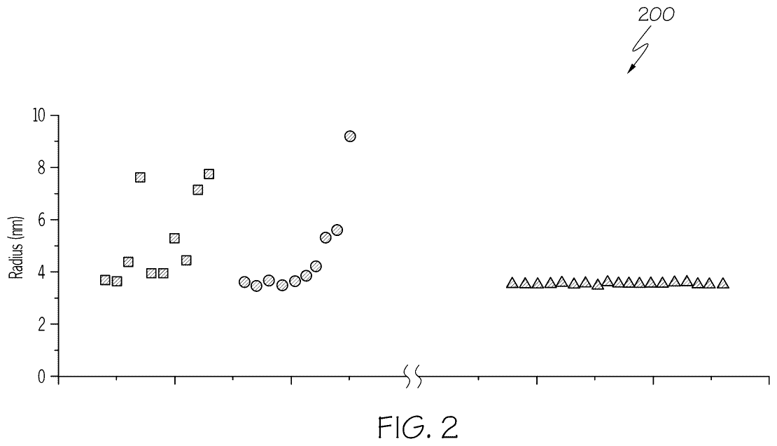

The simultaneous measurement of hydrodynamic radius (r_{g}) looks similar. The first few r_{g} measurements for each stop-flow injection on the left are correct, but rapidly become unstable due to degraded material diffusing into the beam. Again, the slow-flow measurement on the right side of the graph 200 is stable as shown in FIG. 2.

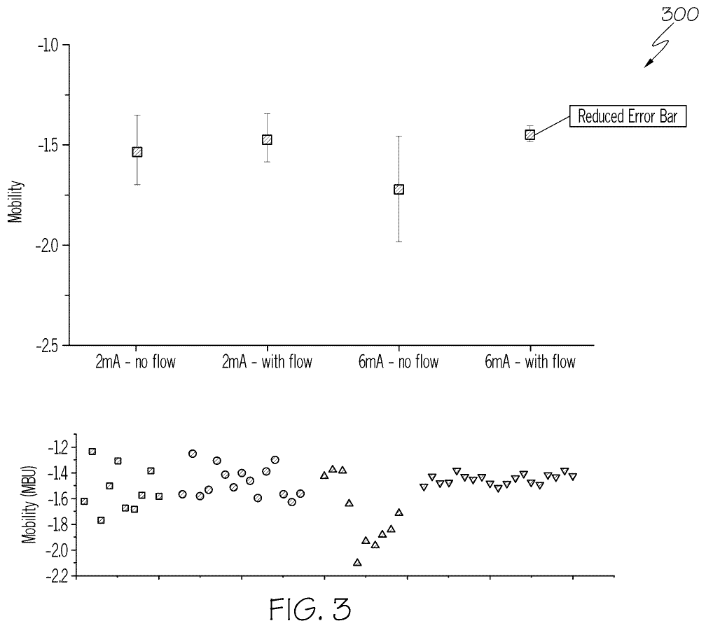

The next experiment compares the performance of the stop-flow to slow-flow for two different applied fields. For example, the flow rate may range from 0-0.1 ml/min. However, a flow rate may be another non-zero constant flow rate. The first set of runs on the left of the graph 300 illustrated FIG. 3 were taken with 2 mA applied to the sample. This field is low enough that the sample does not degrade appreciably during the measurement, but because a relatively low field is applied, the resulting measurements have standard deviation around 20%. As expected, the results for both stop-flow and slow-flow are equivalent, with the slow-flow having only slightly better reproducibility. On the right side are stop-flow and slow-flow measurements for 6 mA applied current. In theory the higher field should make the Doppler shift easier to measure. However, the large error bar is due to the sample degradation. By contrast the rightmost data for slow flow with 6 mA, by eliminating the effect of degradation, realizes improved accuracy.

### Field Applied Parallel to the Flow

The '768 application incorporated by reference above teaches that with an electrophoretic mobility cell that applies an electrical field perpendicular to the applied flow, the effect of the flow does not substantially affect the Doppler shift due to the electrophoretic motion. However, the technique can also be used with flow parallel to the applied field, which is the case when using a folded flat capillary cell. In this cell, the fluid enters through fittings at the top and passes through tube shaped electrodes that apply current to the sample.

The measurement occurs at the bottom of a channel of the cell. In this style of cell, the Doppler shift produced by flowing the sample through the cell is added to the Doppler shift produced by electrophoretic flow driven by the applied field.

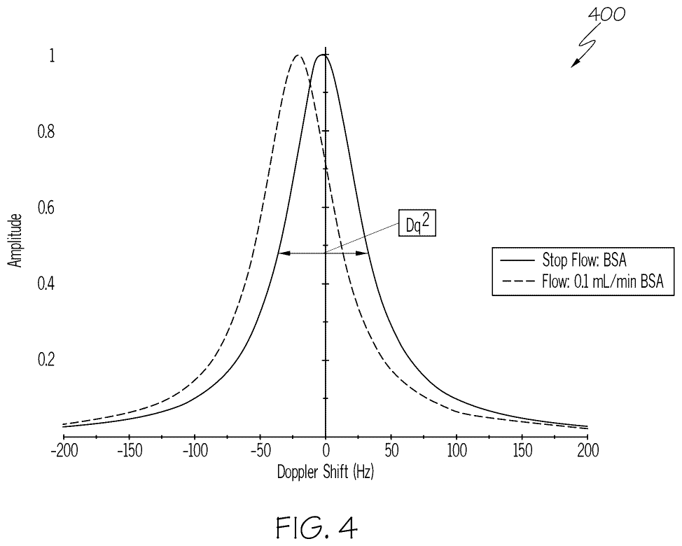

To better understand how the Doppler shift affects the measurement, one must first understand the data that the instrument produces. The ZetaStar™ apparatus is a heterodyne interferometer that measures the spectrum of scattering intensities as a function of frequency difference between the reference beam, which bypasses the cell, and a scattering beam, which is from the light scattered from the molecules. A typical spectrum is illustrated in the graph 400 in FIG. 4. The gray line is the measured spectrum from stop-flow scattering from BSA at 1.0 mg/ml in a flow cell that has high quality (low scattering) windows. The horizontal axis represents the Doppler shift frequency between the two beams.

Because the molecules are undergoing Brownian motion the scattering signal has a Lorentzian spectrum with a width given by D q², where D is the diffusion constant of the scattering molecule, and q is the scattering wave vector

$$q = \frac{4 {π n}_{0}}{{λ}_{0}} sin ( \frac{θ}{2} )$$

and n₀ is the solvent refractive index, λ₀ is the vacuum wavelength of the light, and θ is the scattering angle between the beam and the collection.

The vertical axis is the optical power of the measured scattering intensity (normalized to 1.0).

The red curve is a measurement of the same BSA sample with an applied flow of 0.1 ml/min. Since there is a net flow through the cell, the spectrum is shifted relative to the no-flow data. The magnitude of the frequency shift is proportional to the applied flow. For 0.1 ml/min, the spectrum has shifted by 20 Hz. It is worth noting that even the stationary measurement has a small frequency offset (˜1 Hz), which is likely due to a small residual flow in the cell.

When one applies an electric field, the spectrum acquires an additional frequency shift that is proportional to the induced electrophoretic velocity. Typical electrophoretic Doppler shifts are on the order to 0-20 Hz. When a negative field is applied, the spectrum shifts in the opposite direction. The experiment consists of applying a square wave electric field and measuring the frequency shift for both the positive and negative applied field. The electrophoretic mobility is proportional to the difference between these two conditions. Typical field reversal frequencies are on the scale of 5-10 Hz. When the experiment is performed in this manner, then the Doppler shift associated with flow through the cell, which affects both the positive and negative field measurements equally, cancels leaving only the electrophoretic measurement.

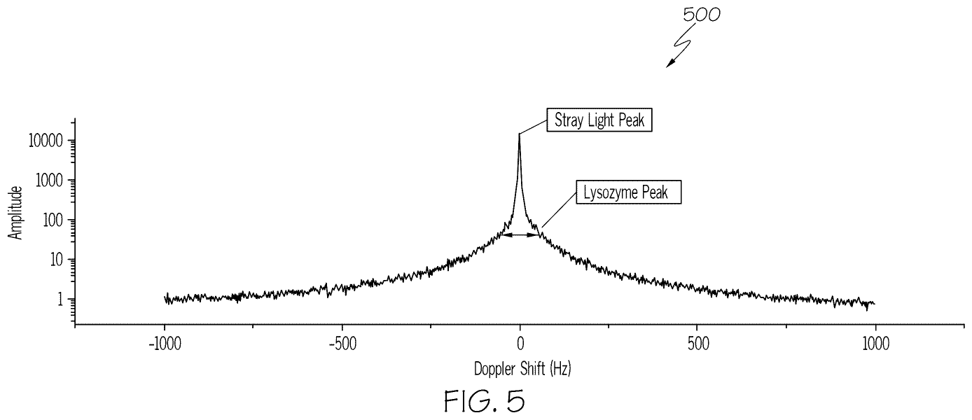

Next consider a measurement from 1 mg/mL Lysozyme in a Tris buffer in the disposable plastic flow cell in accordance with embodiments of the present inventive concept. Since the cell is made from plastic, there is substantial scattering from the windows and the interior of the molded plastic. The scattering spectrum is shown in the graph 500 illustrated in FIG. 5. Again, Doppler broadened peak from Brownian motion of the sample is provided, but superimposed on the spectrum is a large peak from stray light, due to the low-quality optical surfaces (compared to the glass of the flow cell).

The scattering amplitude is now shown on a log scale. The stray light peak is over a factor of 100× larger sample peak. One can apply a bi-modal fit model that disentangles the stray light artifact from the scattering signal, but given the relative magnitude of the two peaks, this is problematic. In this case, it is understood a priori that the stray light peak is an artifact because the sample was carefully prepared to be pure Lysozyme with no contaminants, but one would get a very similar spectrum if one measured a Lysozyme sample that had a small admixture of large particles. In general, one cannot simply assume that the central peak is an artifact, and not part of the sample. The spectrum shown in the graph 500 in FIG. 5, is illustrated with a zero applied field. When one performs the electrophoretic measurement, the resulting peak shifts are only ˜10 Hz and are almost completely masked the by large stray light peak.

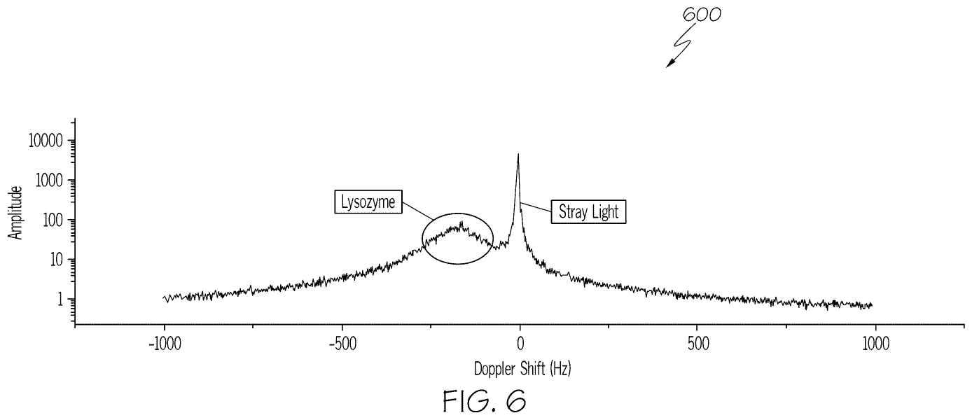

Now consider the effect of applying a flow of 0.1 ml/min to the measurement as shown in the graph 600 illustrated in FIG. 6. Since stray light comes from the flare at optical interfaces, it does not shift in the presence of fluid flow and remains at a Doppler shift of 0 Hz. As before, the applied flow causes the sample peak to shift, however because the field and flow are parallel (as distinguished from perpendicular in the flow cell discussed above), the Doppler shift from the through-flow is around 200 Hz. This is sufficient to completely separate the sample scattering peak from the stray light peak. The stray light peak (at 0 Hz) is now unambiguously distinguished from the sample peak. Since the stray light no longer obscures the center of the sample peak, it is much easier for the fitting to measure the additional Doppler shifts due to the electrophoretic flow. The practical consequence is that one can now perform measurements with extremely weak scattering samples even in low optical quality plastic sample cells.

Measuring rₕ from Heterodyne Light Scattering

While instruments such as the Wyatt ZetaStar™ instrument use a traditional DLS detector to measure the sample hydrodynamic radius, one can also use the scattering spectrum measured by the ELS system to also measure rₕ. As described earlier, the Doppler broadened peak has a width of D q². Since q is known from the laser wavelength, solvent refractive index, and scattering angle, one can extract the diffusion coefficient by fitting the scattering spectrum and extracting the peak width to determine the diffusion constant D. Then one can use the Stokes-Einstein (SE) relationship D=k_{b}T/(6 πηrₕ) to determine rₕ. In the SE equation, k_{b} is Boltzmann's constant, η is the solvent dynamic viscosity, and T is the temperature in Kelvin.

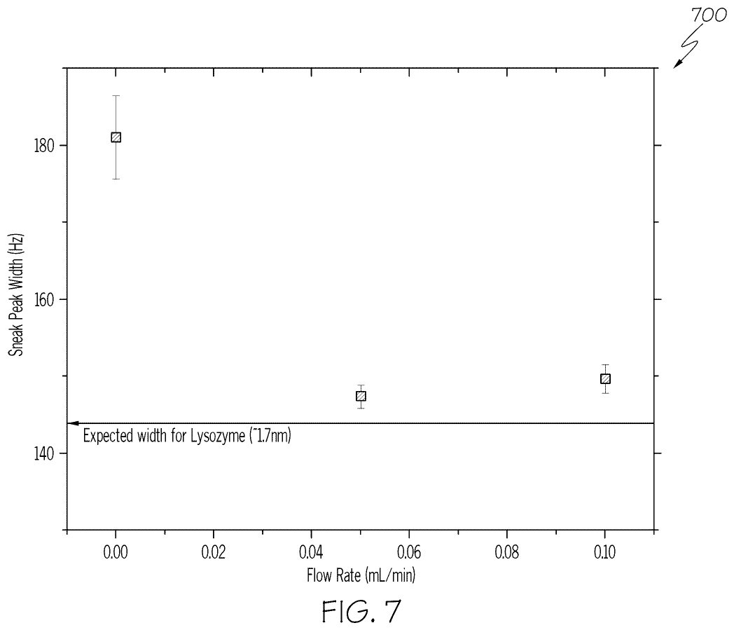

In the past, it has been challenging to measure the hydrodynamic radius this way, because the stray light peak in FIG. 5 makes it difficult to accurately determine the spectrum width. However, with the applied flow the separation between the sample peak and stray light peak greatly improves the accuracy of this method. An example is shown in the graph 700 in FIG. 7, which shows the extracted peak width with and without fluid flow. Based on the known size of Lysozyme, a peak width of 144 Hz is expected. However, when there is no flow, peak fitting algorithm overestimates the width due to presence of large stray light peak. Once some flow is introduced, the fit results are more accurate and resulting width is closer to what is expected for Lysozyme which is 1.7 nm.

### SUMMARY

Historically electrophoretic mobility measurements have always been performed under stop-flow conditions. In this disclosure, it is demonstrated that slowly flowing the sample through the measurement volume can dramatically improve the accuracy and utility of the measurement. When one has a high-quality optical cell for which the flow is perpendicular to the flow, the applied flow adds a very small shift to the scattering spectra. By flushing out damaged sample, electrolysis products, and Joule heat, and flowing in fresh sample, one can integrate for as long as desired to reduce statistical noise. One can use higher applied fields to further improve measurement accuracy or reduce overall measurement time.

When one uses a plastic cuvette, in which the field and flow are co-aligned, the applied flow separates out the stray light signal spectrum from the sample spectrum, dramatically improving the accuracy and allowing measurement of much lower concentrations and lower mobilities than was otherwise possible.

The flow can be supplied with a simple syringe pump, or in a fully automated fashion using a chromatography pump and auto-sampler to allow for large number of unattended measurements.

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometer to microns.

### Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated, generally based on size, mass, or column affinity, the samples may be subjected to analysis by means of light scattering, refractive index, ultraviolet absorption, electrophoretic mobility, and viscometric response.

### Light Scattering

Light scattering (LS) is a non-invasive technique for characterizing macromolecules and a wide range of particles in solution. The two types of light scattering detection frequently used for the characterization of macromolecules are static light scattering and dynamic light scattering.

### Dynamic Light Scattering

Dynamic light scattering is also known as quasi-elastic light scattering (QELS) and photon correlation spectroscopy (PCS). In a DLS experiment, time-dependent fluctuations in the scattered light signal are measured using a fast photo detector. DLS measurements determine the diffusion coefficient of the molecules or particles, which can in turn be used to calculate their hydrodynamic radius.

### Static Light Scattering

Static light scattering (SLS) includes a variety of techniques, such as single angle light scattering (SALS), dual angle light scattering (DALS), low angle light scattering (LALS), and multi-angle light scattering (MALS). SLS experiments generally involve the measurement of the absolute intensity of the light scattered from a sample in solution that is illuminated by a fine beam of light. Such measurement is often used, for appropriate classes of particles/molecules, to determine the size and structure of the sample molecules or particles, and, when combined with knowledge of the sample concentration, the determination of weight average molar mass. In addition, nonlinearity of the intensity of scattered light as a function of sample concentration may be used to measure interparticle interactions and associations.

### Multi-Angle Light Scattering

Multi-angle light scattering (MALS) is an SLS technique for measuring the light scattered by a sample into a plurality of angles. It is used for determining both the absolute molar mass and the average size of molecules in solution, by detecting how they scatter light. Collimated light from a laser source is most often used, in which case the technique can be referred to as multiangle laser light scattering (MALLS). The “multi-angle” term refers to the detection of scattered light at different discrete angles as measured, for example, by a single detector moved over a range that includes the particular angles selected or an array of detectors fixed at specific angular locations.

A MALS measurement requires a set of ancillary elements. Most important among them is a collimated or focused light beam (usually from a laser source producing a collimated beam of monochromatic light) that illuminates a region of the sample. The beam is generally plane-polarized perpendicular to the plane of measurement, though other polarizations may be used especially when studying anisotropic particles. Another required element is an optical cell to hold the sample being measured. Alternatively, cells incorporating means to permit measurement of flowing samples may be employed. If single-particles scattering properties are to be measured, a means to introduce such particles one-at-a-time through the light beam at a point generally equidistant from the surrounding detectors must be provided.

Although most MALS-based measurements are performed in a plane containing a set of detectors usually equidistantly placed from a centrally located sample through which the illuminating beam passes, three-dimensional versions also have been developed where the detectors lie on the surface of a sphere with the sample controlled to pass through its center where it intersects the path of the incident light beam passing along a diameter of the sphere. The MALS technique generally collects multiplexed data sequentially from the outputs of a set of discrete detectors. The MALS light scattering photometer generally has a plurality of detectors.

Normalizing the signals captured by the photo detectors of a MALS detector at each angle may be necessary because different detectors in the MALS detector (i) may have slightly different quantum efficiencies and different gains, and (ii) may look at different geometrical scattering volumes. Without normalizing for these differences, the MALS detector results could be nonsensical and improperly weighted toward different detector angles.

### Electrophoretic Light Scattering

Electrophoretic light scattering (ELS) is a technique used to measure the electrophoretic mobility of particles in dispersion, or molecules in solution. This mobility is often converted to a zeta potential to enable comparison of materials under different experimental conditions. The fundamental physical principle is that of electrophoresis. A dispersion is introduced into a cell containing two electrodes. An electrical field is applied to the electrodes, and particles or molecules that have a net charge, or more strictly a net zeta potential will migrate towards the oppositely charged electrode with a velocity. The mobility, which is the ratio of the measured velocity to the applied electric field, is related to their zeta potential.

When an electric field is applied to a sample, any charged objects in the sample will be influenced by that field. The extra movement that particles exhibit as a result of them experiencing the electric field is called the electrophoretic mobility. Its typical units are μm·cm/V·s (micrometer centimeter per Volt second) since it is a velocity [μm/s] per field strength [V/cm]. The electrophoretic mobility is the direct measurement from which the zeta potential can be derived (using either the Smoluchowski/Debye-Hückel approximations or the complete Henry function F(κa) to get from the mobility to a zeta potential).

What is claimed is:

1. A computer implemented method, comprising:
flowing a sample through a sample cell at a flow rate;
applying an electric field to the sample while the sample is flowing through the sample cell;
measuring electrophoretic mobility of particles in the sample using light scattering techniques while the sample is flowing and the electric field is applied;
wherein the flowing removes degraded sample particles from a measurement region of the sample cell during the measuring and replaces the degraded sample particles with a fresh sample;
wherein the flowing removes heat generated by Joule heating from the measurement region; and
wherein the flowing enables an application of a higher electric field strength, thereby increasing a Doppler shift and reducing measurement time and measurement error.

2. The method of claim 1, wherein the flow rate has a range of 0-1.0 mL/min.

3. The method of claim 1, further comprising accompanying the electrophoretic mobility measurement with a simultaneous Dynamic Light Scattering (DLS) measurement of a hydrodynamic radius of the particles in the sample.

4. The method of claim 1, wherein the sample cell comprises at least two electrodes spaced to define a measurement volume, and wherein the sample is refreshed within the measurement volume at predetermined intervals of approximately 30 seconds to maintain accuracy of the mobility measurement throughout a duration of the flowing of the sample.

5. The method of claim 4, wherein an increased electric field is applied across the at least two electrodes to induce a higher electrophoretic velocity in the sample, thereby producing a greater Doppler shift.

6. The method of claim 1, wherein the light scattering techniques include a detector comprising a heterodyne interferometer configured to measure the Doppler shift induced by scattering light off the particles.

7. The method of claim 1, wherein measuring a scattering spectrum by the light scattering techniques comprises:
acquiring intensity data as a function of Doppler frequency shift;
fitting the acquired spectrum to extract a spectral width indicative of Brownian motion;
calculating a diffusion coefficient from the spectral width using a known scattering wave vector; and
determining a hydrodynamic radius of the particles using a Stokes-Einstein relationship based on the diffusion coefficient, a known solvent viscosity, and a known temperature.

8. The method of claim 1, wherein the electric field is applied perpendicular to a direction of the flowing.

9. The method of claim 1, wherein the electric field is applied parallel to a direction of the flowing, and wherein the flowing separates a sample scattering peak from a stray light peak in a scattering spectrum.

10. A method for improving sensitivity and accuracy of electrophoretic mobility measurements, comprising:
applying a slow flow to continuously remove a sample from a measurement cell during a measurement operation involving an application of electrical current;
replacing the removed sample with fresh sample during the measurement operation;
applying higher electric fields than would be possible without the slow flow; and
extending measurement times beyond what would be achievable without the slow flow;
wherein the continuous removal and replacement of sample enables the application of higher fields and longer measurement times, thereby improving sensitivity and accuracy of the measurement operation.

11. The method of claim 10, wherein the measurement operation comprises:
applying the electrical current forming an electric field to the sample while the sample is flowing through the measurement cell; and
measuring electrophoretic mobility of the particles in the sample using light scattering techniques while the sample is flowing and the electric field is applied.

12. The method of claim 11, wherein the light scattering techniques comprise electrophoretic light scattering using a heterodyne method that measures Doppler shift induced by scattering light off moving particles.

13. The method of claim 11, wherein the electric field is applied perpendicular to a direction of the flowing.

14. The method of claim 11, wherein the electric field is applied parallel to a direction of the flowing, and wherein the flowing separates a sample scattering peak from a stray light peak in a scattering spectrum.

15. The method of claim 14, wherein the stray light peak remains at a Doppler shift of 0 Hz while the sample scattering peak shifts due to the flowing, thereby enabling measurement of particles in low optical quality sample cells.

16. The method of claim 10, wherein during the slow flow, electrolysis products and degraded sample particles are from a measurement region of the measurement cell and replaced with the fresh sample.

17. The method of claim 10, wherein the flowing of the sample removes heat generated by Joule heating from the measurement region.

18. A system for electrophoretic mobility measurement, comprising:
a sample cell configured to contain a sample having particles;
a flow system configured to flow the sample through the sample cell at a non-zero flow rate; and
electrodes configured to apply an electric field to the sample in the sample cell;
a light scattering detector configured to measure electrophoretic mobility of the particles while the sample flows through the sample cell and the electric field is applied, wherein the flow system is configured to continuously remove electrolysis products and degraded sample particles from a measurement region and replace them with fresh sample.

19. The system of claim 18, wherein the electrodes are configured to apply the electric field perpendicular to a direction of flow of the sample through the sample cell.

20. The system of claim 18, wherein the electrodes are configured to apply the electric field parallel to a direction of flow of the sample through the sample cell, and wherein the flow system is configured to separate a sample scattering peak from a stray light peak in a scattering spectrum.
